(19) United States
(12) Patent Application Publication
(10) Pub. No.: US 2011/0015014 A1
(43) Pub. Date: Jan. 20, 2011

(54) MODULE FOR A TENSIONING ELEMENT MEANS DRIVE CONCEPT

(75) Inventors: Petrus Hubertus Kroon, Erlangen (DE); Michael Kastner, Hirschaid (DE)

Correspondence Address: VOLPE AND KOENIG, P.C., UNITED PLAZA, 30 SOUTH 17TH STREET, PHILADELPHIA, PA, 19103, US

(73) Assignee: SCHAEFFLER TECHNOLOGIES GMBH & CO. KG, Herzogenaurach (DE)

(21) Appl. No.: 12/739,816

(22) PCT Filed: Sep. 17, 2008
(86) PCT No.: PCT/EP2008/062364

§ 371 Date: Sep. 21, 2010

(30) Foreign Application Priority Data
Oct. 26, 2007 (DE) 102007051627.6
Apr. 25, 2008 (DE) 102008020741.1

(51) Int. Cl. F16H 7/08

(52) U.S. Cl. 474/110; 474/111

(57) ABSTRACT

A tensioning system (1) configured as a module solution and which has a drive gear (3) and a driven gear (5) connected via a tensioning element (4). A carrier element (8) is disposed in an installation space (6) that is limited by the tensioning gears, the drive gear (3) and the driven gear (5) and a tight side (13) and a slack side (16) of the tensioning element (4). All components of the tensioning system are captively combined via the carrier element (8) to form an externally pre-mountable assembly, that can be delivered, for example, to an internal combustion engine.

### BACKGROUND

The present invention relates to a tensioning element drive configured as a module solution, in particular, a chain drive that includes a drive wheel and at least one driven wheel, as well as a tensioning element that connects the tensioning wheels and that is loaded by a tensioning device.

Tensioning element drives of the type noted above are known, for example, from the documents DE 198 05 874 A1 and U.S. Pat. No. 6,106,423. These tensioning element drives show a construction in which the tensioning rails or guide rails engage the tensioned or slack sections of the tensioning element, wherein the required installation space for the entire tensioning element drive is increased accordingly. Depending on the type of construction, these known tensioning element drives require a separate assembly of all of the individual parts. In particular, timing drives require, depending on their function, an exact positioning of the individual chain wheels, in order to guarantee specific timing parameters of the internal combustion engine. For this purpose, an especially costly and time-intensive assembly procedure is required, in order to mount the tensioning element drive.

### SUMMARY

The invention is therefore based on the objective of developing a concept for a tensioning element drive that allows simplified assembly.

The objective noted above is met by the features of Claim 1. For creating a tensioning element drive constructed as a module, a carrier element is provided that is positioned in an installation space of the tensioning element drive bounded by the tensioning element wheels and tensioned and slack sections of the tensioning element. The carrier element is here provided with devices through which all of the components of the tensioning element drive are combined captively secured to form one component that can be preassembled externally. Advantageously, after successful preassembly, the tensioning element drive module solution allows an automated assembly on the internal combustion engine, without supplemental or additional manual handling. In this way, an error-free, accelerated, and cost-optimized assembly of the tensioning element drive can be realized. Furthermore, an installation-space-optimized tensioning element drive is provided by the invention, because all of the elements guiding or biasing the tensioning element are placed in an installation space that is enclosed by the tensioning element or the tensioning element wheels. The module solution forming the basis of the invention relates to a novel holding, guiding, and attachment element for a tensioning element drive that offers decisive advantages with respect to transport and assembly and here offers accelerated assembly without qualitative limitations, in that the new concept allows all of the system components to be installed in one process.

Additional advantageous constructions of the invention are the subject matter of the dependent Claims 2-7.

A preferred construction of the invention provides a carrier element that is made, in particular, from plastic and that has the following shape or to which the following components are allocated: a hydraulic tensioning device in connection, in particular, with the slack section of the tensioning element drive, as well as a preferably rigidly positioned guide rail allocated to the tensioned section of the tensioning element. Furthermore, the carrier element has spacers for the tensioning element wheels, in order to fix these captively secured by the tensioning element. The carrier element is furthermore provided integrally with an anti-jumping device that is shaped advantageously as a guide shoe and that is arranged, for example, in the region of a chain wheel at a distance from the outer contours of the tensioning element. Furthermore, for the carrier element according to the invention it is provided that this element includes preferably arc-shaped grooves or channels that are designed for the loose holding of the tensioning element wheels constructed as chain wheels. Furthermore, the carrier element includes measures for guaranteeing a secure guidance of a piston-slide shoe and for realizing the guide rails. Furthermore, the carrier element comprises at least one holder by which a drive shaft is guided on which or at which a tensioning element wheel can be fixed.

The hydraulic tensioning device integrated in the carrier element or alternatively mounted detachably on the carrier element is preferably loaded by a hydraulic fluid of the internal combustion engine. A slide shoe that is supported in the operating state on the inside on the tensioning element, preferably in the region of the slack section, is allocated on the end side to the piston guided in a line in the hydraulic tensioning device. The piston end side or the guide shoe is here advantageously provided with a vent by which the simultaneously outgoing hydraulic fluid can be guided for the targeted lubrication on the tensioning element.

As additional measures simplifying the assembly it is offered to fix the piston of the tensioning system by a securing device, in particular, a pin in a position that does not tension the tensioning element. After successful assembly of the tensioning element drive module, the pin is removed, and the tensioning element is simultaneously biased.

The concept of the module solution according to the invention can be used preferably for a compensation shaft drive with which vibrational damping can be achieved in the internal combustion engine. The drive is here realized by a tensioning element wheel allocated to the crankshaft and constructed, in particular, as a chain wheel.

The compensation shaft drive is here realized offset or separate from a timing drive and assembly drive of the internal combustion engine.

The construction of the carrier element also provides an anti-jumping device for the tensioning element of an additional upstream tensioning element drive, in particular, the timing drive of the internal combustion engine.

### BRIEF DESCRIPTION OF THE DRAWINGS

Additional advantages and details of the invention are described below using embodiments with reference to the figures. The figures show:

FIG. 1 the tensioning element drive according to the invention in the installed state,

FIG. 2 a perspective view of the tensioning element drive according to the invention and constructed as a module,

FIG. 3 a top view of the carrier element in connection with all components,

FIG. 4 a perspective view of the base plate of the carrier element as an individual part,

FIG. 5 a detailed view of the guide unit.

### DETAILED DESCRIPTION OF THE PREFERRED EMBODIMENTS

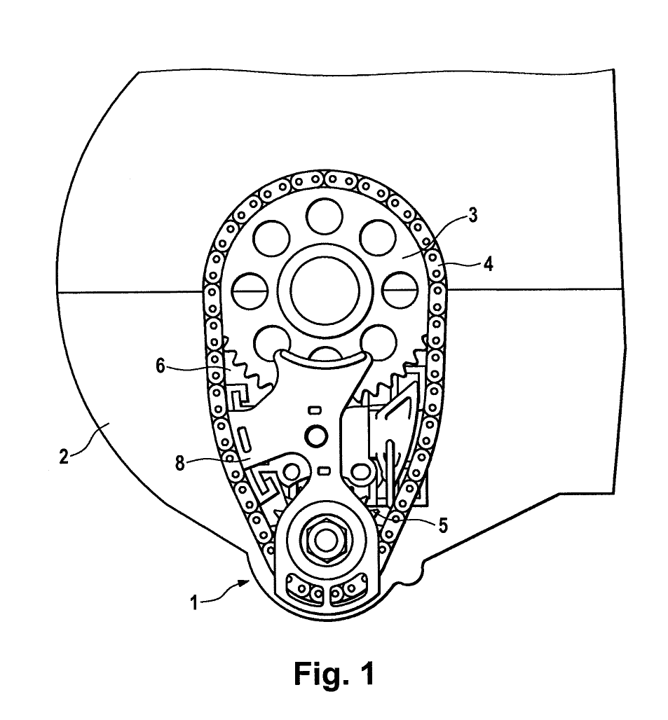

FIG. 1 shows the tensioning element drive 1 according to the invention and assembled as a module into a structural unit in the installed state. The tensioning element drive 1 is used as a compensation shaft drive of an internal combustion engine 2. As the drive wheel 3, a chain wheel is provided that is in connection with a crankshaft of the internal combustion engine 2 and that is connected by a tensioning element 4, a chain, to a driven wheel 5 connected to a drive shaft not shown in FIG. 1. A carrier element 8 is positioned in an installation space 6 enclosed by the chain wheels, the drive wheel 3, and the driven wheel 5, as well as the tensioning element 4.

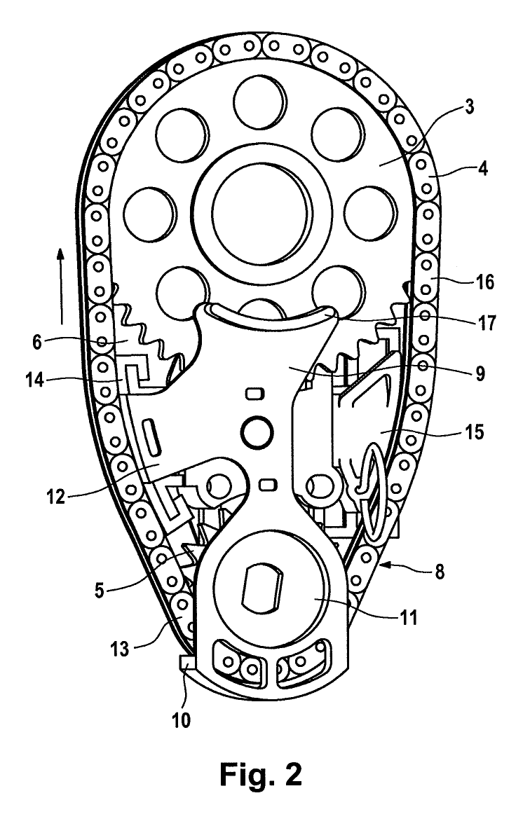

For illustrating the tensioning element drive 1 constructed as a module, this is shown as an individual part in FIG. 2. All of the components of the tensioning element drive 1 rotating in the clockwise direction are assembled using the carrier element 8 into a structural unit, a module. The carrier element 8 comprises a base plate 9 that extends on one side with a leg 7 across the outer contours of the driven wheel 5 and wraps around this wheel within limits at a distance from the outer contours of the tensioning element 4 and here forms an anti-jumping device 10 for the tensioning element 4. The leg 7 of the base plate 9 here includes a circular-ring-shaped holder 11 through which a drive shaft is guided in the installed state for holding the driven wheel 5. The base plate 9 is furthermore connected integrally to a guide unit 12 that includes a rigidly positioned guide rail 14 allocated to the tensioned section 13 of the tensioning element drive 1. Furthermore, a tensioning device 15 is mounted on the base plate 9, with this tensioning device being supported on the inside on the tensioning element 4 in the region of a slack section 16. In addition, the base plate 9 encloses an additional anti-jumping device 17 that is designed for a separate tensioning element drive that is offset in the axial direction relative to the tensioning element drive 1 and that is not shown in FIG. 2, for example, the timing drive of the internal combustion engine.

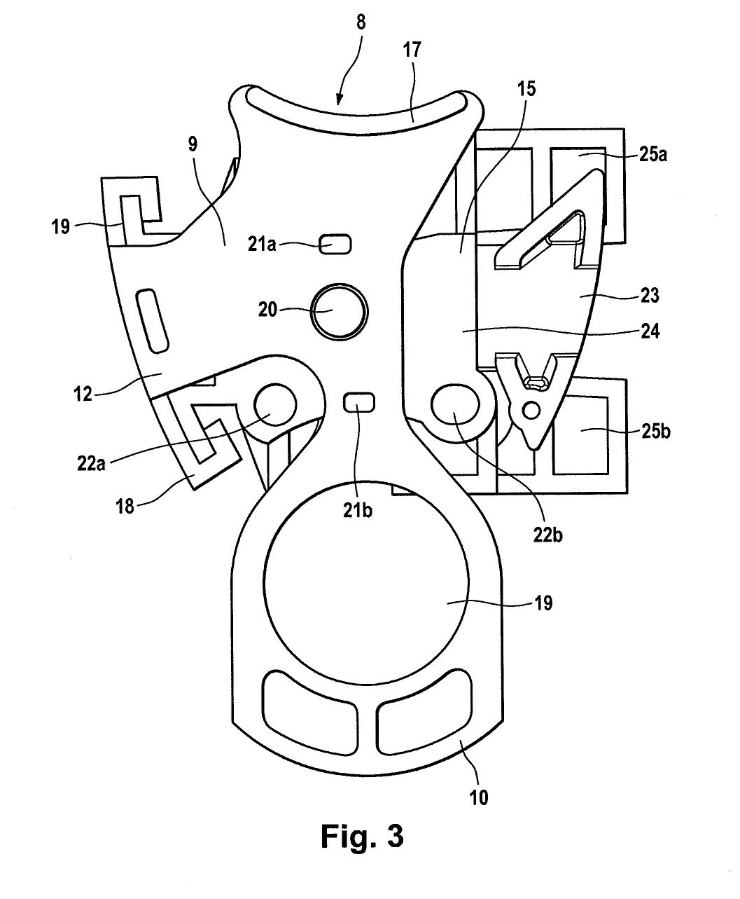

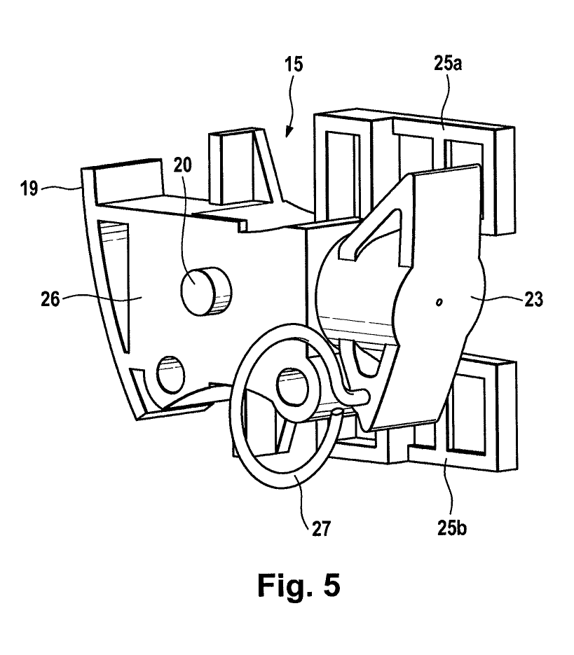

FIG. 3 illustrates additional details of the carrier element 8. The base plate 9 produced from plastic forms, in the region of the guide unit 12, a guide rail 18 whose arc-shaped construction corresponds to a contact 19 that is a component of the tensioning device 15 produced from an aluminum material and shown in FIG. 5. This construction guarantees a buckling-resistant guide rail 18. For positioning and fixing the tensioning device 15 relative to the base plate 9, the attachment points 20, 21a, 21b are provided. For fixing the carrier element 8, including all of the components, in particular, on the internal combustion engine, there are attachment boreholes 22a, 22b. The tensioning device 15 has, on the end of the piston, a slide shoe 23 that is supported in the installation state, on the tensioning element 4 in the region of the slack section 16. The slide shoe 23 is guided on two anti-rotation devices 25a, 25b allocated to a housing 24 of the tensioning device 15.

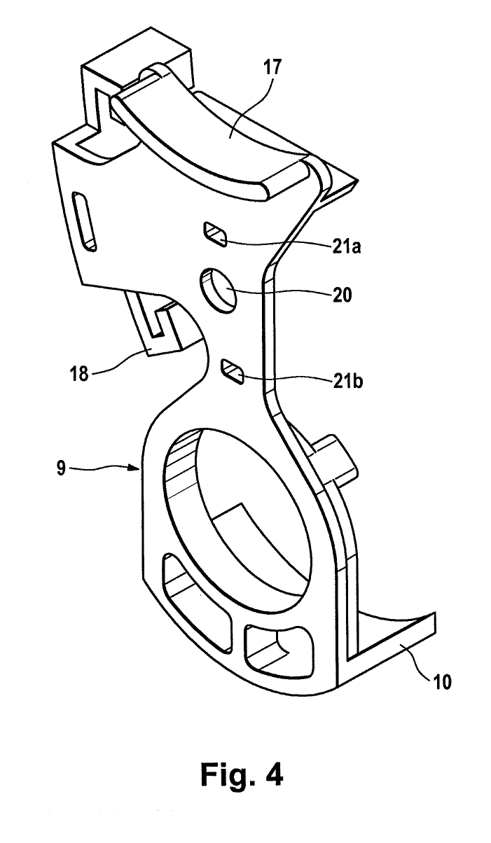

The structural setup of the base plate 9 is shown in FIG. 4. This figure shows, in particular, the axial offset between the anti-jumping device 10 that is allocated according to FIG. 2 to the driven wheel 5 of the tensioning element drive 1 and the additional anti-jumping device 17 that is allocated, for example, to a timing drive of the internal combustion engine.

In FIG. 5, the tensioning device 15 is shown as an individual part that is supported on the base plate 6 by a contact face 26. According to FIG. 5, the slide shoe 23 is connected to the associated piston in an end position, i.e., in the retracted piston position above a pin 27. The pin 27, which is guided by the slide shoe 23 and inserted into a corresponding borehole of the anti-rotation device 25b, simplifies the assembly of the tensioning element drive based on an unbiased tensioning element 4. After successful assembly of the tensioning element drive and subsequent attachment of the carrier element 8, the pin 27 is removed, wherein the slide shoe 23 biases the tensioning element 4 in connection with the piston shifted in a line.

### LIST OF REFERENCE SYMBOLS

1 Tensioning element drive
2 Internal combustion engine
3 Drive wheel
4 Tensioning element
5 Driven wheel
6 Installation space
7 Leg
8 Carrier element
9 Base plate
10 Anti-jumping device
11 Holder
12 Guide unit
13 Tensioned section
14 Guide rail
15 Tensioning device
16 Slack section
17 Anti-jumping device
18 Guide rail
19 Stop
20 Attachment point
21a Attachment point
21b Attachment point
22a Attachment borehole
22b Attachment borehole
23 Slide shoe
24 Housing
25a Anti-rotation device
25b Anti-rotation device
26 Stop face
27 Pin

1. A modular tensioning element drive for a chain drive of an internal combustion engine, comprising a drive wheel and at least one driven wheel, a tensioning element connecting the tensioning element wheels and loaded by a tensioning device, and a carrier element upon which all components of the tensioning element drive are assembled captively secured in a structural unit that can preassembled externally and that can be supplied on an internal combustion engine, the carrier element is arranged in an installation space bounded by the drive wheel, the driven wheel, as well as a tensioned section and a slack section of the tensioning element drive.

2. The modular tensioning element drive according to claim 1, wherein the carrier element guarantees a captively secured positioning of all of the components of the tensioning element drive in a preassembled state and a reliable function in an operating state, the carrier element including the following components or molded parts:
a base plate produced from plastic,
a tensioning device,
a guide rail allocated to the tensioned section,
spacers for the tensioning element wheels, the drive wheel, as well as the driven wheel,
at least one anti-jumping device constructed as a guide shoe,
an anti-rotation device for the slide shoe of the tensioning device, and
at least one holder for passing through a drive shaft adapted to engage the driven wheel.

3. The modular tensioning element drive according to claim 1, further comprising a hydraulic tensioning device having a piston that can be shifted linearly and that is loaded by a hydraulic fluid of the internal combustion engine and is supported against a slide shoe on an inside on the tensioning element in a region of the slack section.

4. The modular tensioning element drive according to claim 3, wherein the hydraulic tensioning device has, on an end face of the piston or the slide shoe, a vent by which outgoing hydraulic fluid is guided onto the tensioning element.

5. The modular tensioning element drive according to claim 3, wherein the piston of the tensioning system can be fixed in a retracted position with a pin.

6. The modular tensioning element drive according to claim 1, wherein the tensioning element drive is adapted to be used for a compensation shaft drive of an internal combustion engine.

7. The modular tensioning element drive according to claim 1, wherein the carrier element includes an anti-jumping device for an additional tensioning element drive connected upstream relative to the tensioning element drive.
